(19) United States
(12) Patent Application Publication
(10) Pub. No.: US 2012/0318391 A1
(43) Pub. Date: Dec. 20, 2012

(54) PULLING-WIRE WATERWAY SWITCHING MECHANISM

(75) Inventors: Huasong Zhou, Xiamen (CN); Yanhui Zhong, Xiamen (CN); Jianmin Chen, Xiamen (CN); Bin Chen, Xiamen (CN)

(73) Assignees: Xiamen Solex HighTech Industries Co., Ltd., Xiamen, Fujian (CN); Huasong Zhou, Xiamen, Fujian (CN)

(21) Appl. No.: 13/580,037

(22) PCT Filed: Feb. 22, 2011
(86) PCT No.: PCT/CN2011/071165

§ 371 Date: Aug. 20, 2012

(30) Foreign Application Priority Data
Mar. 3, 2010 (CN) 201010117045.9
Mar. 3, 2010 (CN) 201020122478.9

(51) Int. Cl. F16K 11/074

(52) U.S. Cl. 137/625.46

(57) ABSTRACT

A pulling-wire waterway switching mechanism has a fixed unit, a water division body, a ratchet shaft, a stopping claw, a returning body and a pulling wire. The water division body can be rotationally arranged in the fixed unit, and can use the rotation between the water division body and the fixed unit to achieve the switch of the outlet functions, a plurality of lower ratchets in anuular array are arranged on the top surface of the water division body, and a plurality of stopping teeth in anuular array are arranged on the outer rotative surface of the water division body. The ratchet shaft provided with a pulling block extending out of the fixed unit and a plurality of upper ratchets in annular array. The pulling block drives the ratchet shaft to rotate forward. The upper ratchets can drive the water division to rotate forward.

### FIELD OF THE INVENTION

The present invention relates to a waterway switching mechanism of bathroom equipments, more particularly to a pulling-wire waterway switching mechanism.

### BACKGROUND OF THE INVENTION

The utility mode <the pulling-wire outlet functions switch shower head> (authorized announcement number CN201143473Y) disclosed by the china patent database on Nov. 5, 2008 mainly comprises the body of the shower head, the outlet panel and the water division system fixed between the body of the shower head and the outlet panel, and also comprises the driving device driving the rotation of the water division system, and a pulling wire is used for pulling the driving part of the driving device to drive the water division system to rotate, more than one through inlet and outlet are simultaneously opened on the corresponding positions of the water division system. The water division system is rotated, so that one inlet of the water division system is communicated with the outlet of the body of the shower head, and at the same time the outlet of the water division system corresponding to the inlet is communicated with the corresponding function port of the outlet panel. The water division switch function of the shower head is achieved through pulling the pulling wire. Although one new switching way is disclosed from the technical proposal, the following technical matters are still present: first of all, the layout is complicated; second, to achieve circular switch, the driving part is needed to be rotated 360 degree, but it is inconvenient to achieve the 360 degree circulation of the driving part directly through pulling wire, and it is not easy to switch.

### SUMMARY OF THE INVENTION

A pulling-wire waterway switching mechanism is offered in the present invention, which overcomes the defect at the prior art.

The technical proposal to solve the technical matter in the present invention is:

Pulling-wire waterway switching mechanism comprises:

A fixed unit with a plurality of outlet functions;

A water division body, can be rotationally arranged in the fixed unit, and can use the rotation between the water division body and the fixed unit to achieve the switch of the outlet functions, a plurality of lower ratchets in anuular array are arranged on the top surface of the water division body, and a plurality of stopping teeth in anuular array are arranged on the outer rotative surface of the water division body;

A ratchet shaft, can be rotationally arranged in the fixed unit and is provided with a pulling block extending out of the fixed unit and a plurality of upper ratchets in anuular array, and the upper ratchets are adaptive to the lower ratchets, and the ratchet shaft is driven to rotate forward by the pulling block, and the water division can be driven to rotate forward by the upper ratchets through the lower ratchets;

A stopping claw, one end is connected to the fixed unit, another end is adaptive to the stopping teeth to prevent the water division body reversing;

A returning body, is connected between the ratchet shaft and the fixed unit to cause the ratchet shaft reverse and reset; and

A pulling wire, one end is connected to the pulling block.

In a preferred embodiment, the rotation axis of the water division body is coincided with the rotation axis of the ratchet shaft.

In a preferred embodiment, the fixed unit comprises:

A connector, is provided with a upper connection seat, a lower connection seat and a connecting tube, the upper connection seat is connected to the water resource, the connecting tube is fixedly arranged between the upper connection seat and the lower connection seat and guides water from the upper connection seat to the lower connection seat;

A main body, is fixed to the lower connection seat; and

An outlet terminal, is fixed under the main body.

In a preferred embodiment, the upper end of the ratchet shaft is hinged to the upper connection seat, the lower end rotationally extends into the lower connection seat, the upper ratchet is located in the main body, and the pulling block is located between the upper connection seat and the lower connection seat;

The water division body is located in the main body.

In a preferred embodiment, the outlet terminal is provided with a plurality of outlet functions, and each outlet function is provided with a water division hole; a sealing component is arranged under the water division body, and the sealing component can seal any water division hole.

In a preferred embodiment, the upper ratchet is provided with two first vertical faces and a first oblique guiding face connected between the two ends of the two first vertical faces;

The lower ratchet is provided with a second vertical faces and a second oblique guiding face connected to the second vertical face, and the second oblique guiding face is adaptive to the first oblique guiding face.

In a preferred embodiment, a third oblique guiding face is arranged between the second oblique guiding face and the second vertical face, and the oblique direction of the third oblique guiding face is opposite to the oblique direction of the second oblique guiding face.

In a preferred embodiment, the stopping claw is fixedly arranged in the fixed unit through a vertical rod, and the stopping teeth are a plurality of cuboids arranged on the outer rotative surface of the water division body; the end of the stopping claw is adaptive to the stopping teeth of the water division body to limit the reversing of the water division.

Compared with the shower at the prior art, the advantages of the present invention are:

1 The stopping mechanism that prevents reversing and resetting body that resets are used in the rotary waterway switch and pulling-wire driving, which is convenient to achieve 360 degree circular switch, and it is easy to switch;

2 The layout is reasonable with simple structure and low space occupation;

3 The third oblique guiding face is further arranged to ensure completely reset of the reversing of the ratchet shaft, so that the phenomenon that reset cannot fully achieved caused by the non-enough cost of elastic energy can be prevented;

4 The upper end of the ratchet shaft is hinged to the upper connection seat, and the lower end rotationally extends into the lower connection seat, the upper ratchet is located in the main body, and the pulling block is located between the upper connection seat and the lower connection seat, so the sealing performance is good, and the space for the rotation of the pulling block is offered.

### BRIEF DESCRIPTION OF THE DRAWINGS

FIG. 1 shows the using abridged general view of the pulling-wire waterway switching mechanism offered by the preferred embodiment in the present invention;

FIG. 2 shows the exploded view of the pulling-wire waterway switching mechanism offered by the preferred embodiment in the present invention;

FIG. 3 shows the solid abridged general view of the main parts of the pulling-wire waterway switching mechanism offered by the preferred embodiment in the present invention;

FIG. 4 shows the first solid abridged general view of the water division body of the pulling-wire waterway switching mechanism offered by the preferred embodiment in the present invention;

FIG. 5 shows the second solid abridged general view of the water division body of the pulling-wire waterway switching mechanism offered by the preferred embodiment in the present invention;

FIG. 6 shows the solid abridged general view of the main body of the pulling-wire waterway switching mechanism offered by the preferred embodiment in the present invention;

FIG. 7 shows the solid abridged general view of the ratchet shaft of the pulling-wire waterway switching mechanism offered by the preferred embodiment in the present invention;

FIG. 8 shows the sectional view of the pulling-wire waterway switching mechanism offered by the preferred embodiment in the present invention, water comes out of the first state at this moment;

FIG. 9 shows the sectional view of FIG. 8 C1-C1;

FIG. 10 shows the sectional view of the pulling-wire waterway switching mechanism offered by the preferred embodiment in the present invention, water comes out of the second state at this moment;

FIG. 11 shows the sectional view of FIG.10 C2-C2;

FIG. 12 shows the sectional view of the pulling-wire waterway switching mechanism offered by the preferred embodiment in the present invention, water comes out of the third state at this moment;

FIG. 13 shows the sectional view of FIG. 12 C3-C3;

### DESCRIPTION OF THE PREFERRED EMBODIMENTS

With the following description of the drawings and specific embodiments, the invention shall be further described in details.

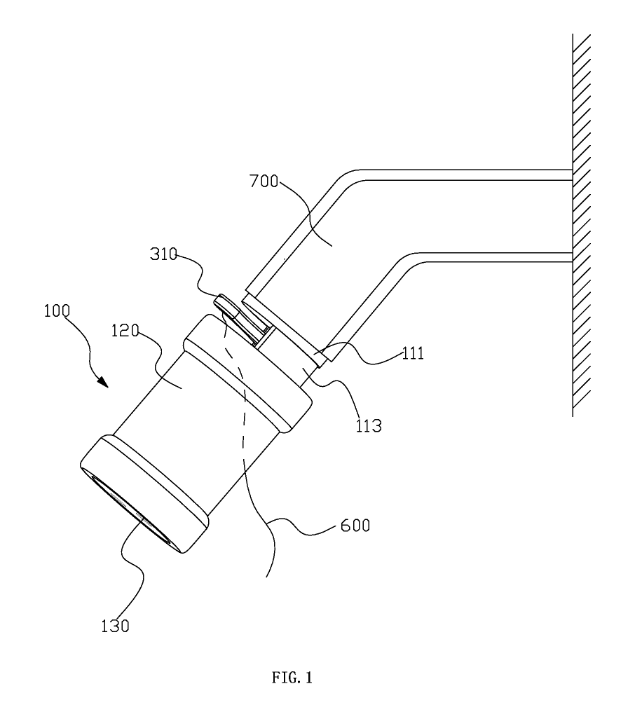

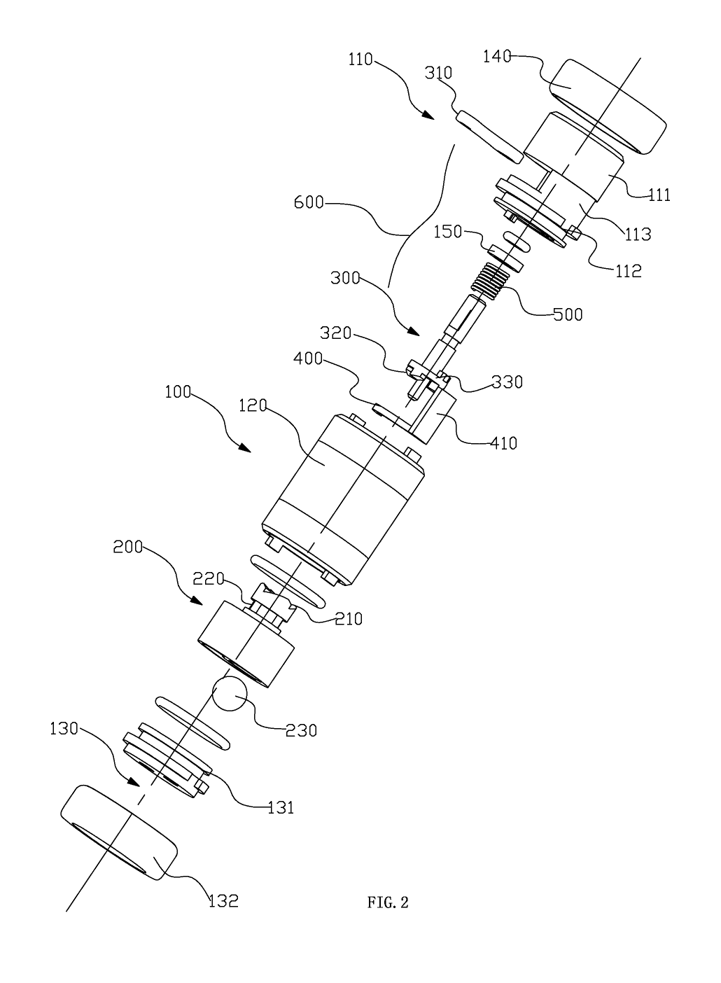

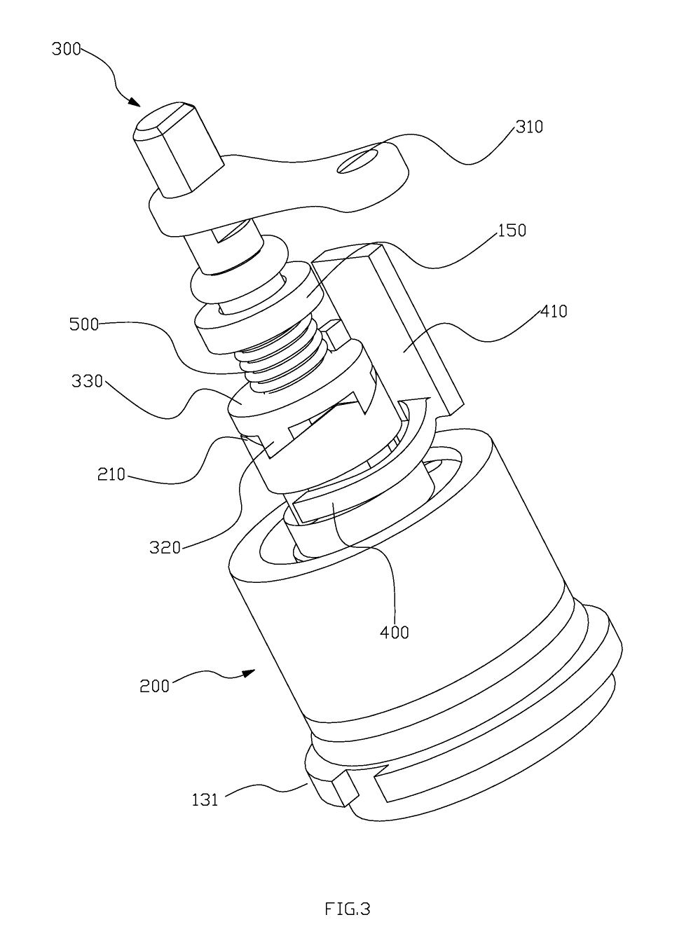

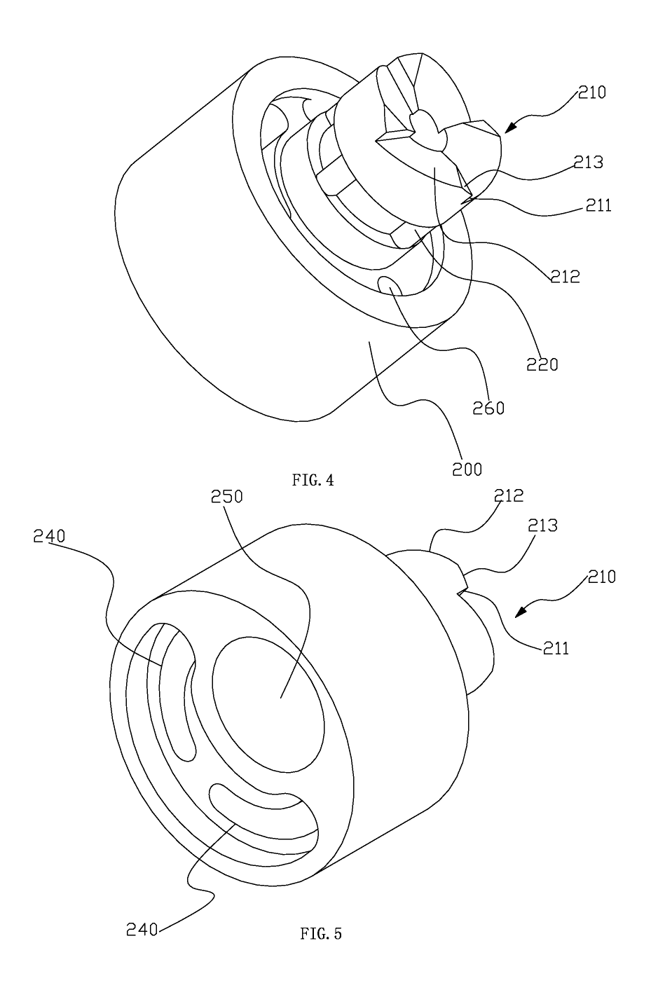

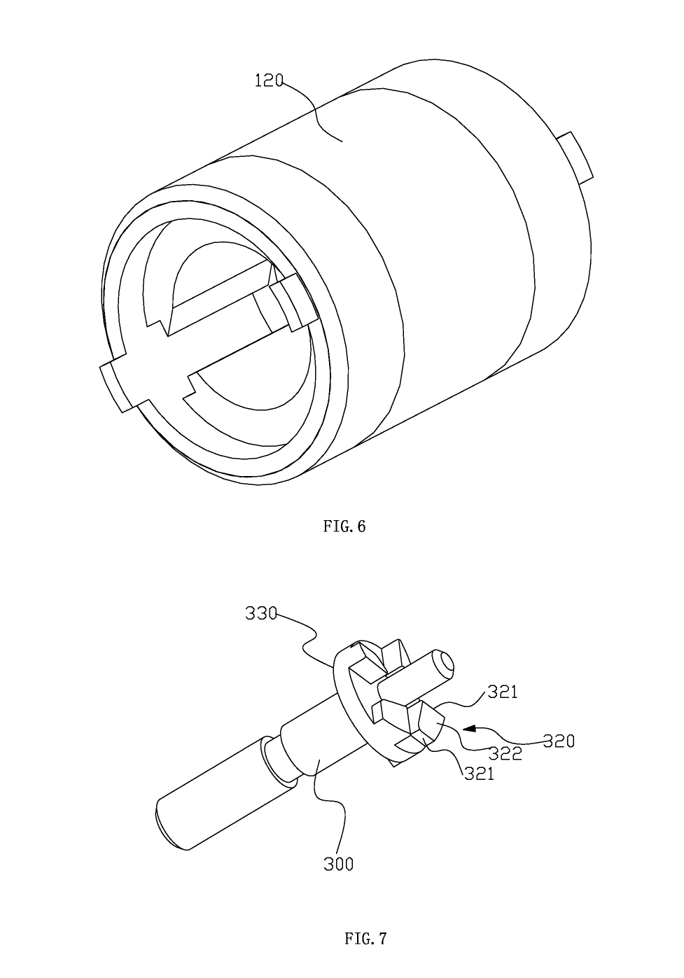

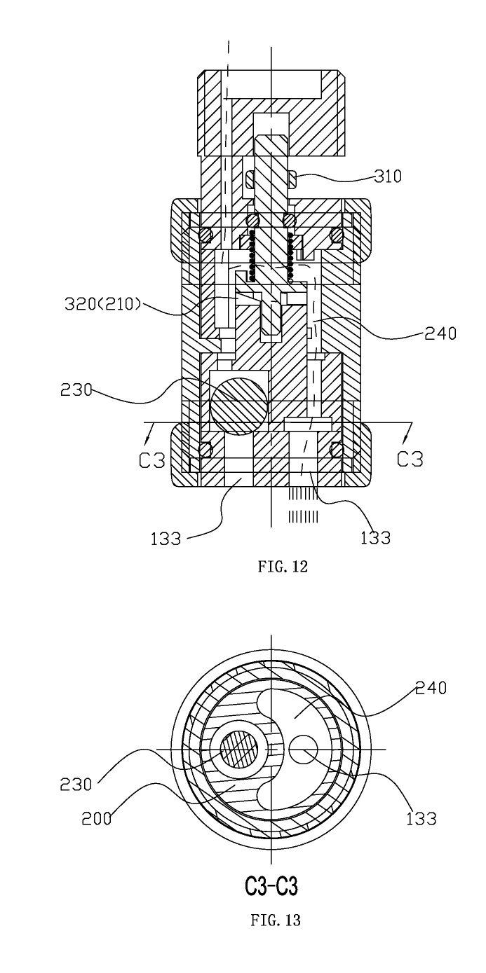

According to FIG. 1 to FIG. 13, the pulling-wire waterway switching mechanism offered by the preferred embodiment in the present invention is present.

The pulling-wire waterway switching mechanism comprises a fixed unit 100, a water division body 200, a ratchet shaft 300, a stopping claw 400, a returning body 500 and a pulling-wire 600.

The fixed unit 100 comprises a connector 110, a main body 120, an outlet terminal 130, a first cover 140 and a check ring 150. The connector 110 is provided with an upper connection seat 111, a lower connection seat 112 and a connecting tube 113, which can be formed in one piece. The upper connection seat 111 is fixed connected to the water resource, such as the American support arm in FIG. 1. The upper end of the connecting tube 113 is fixedly arranged and communicated with the eccentric position of the upper connection seat 111, and the lower end of the connecting tube 113 is fixedly arranged and communicated with the eccentric position of the lower connection seat 112, the connecting tube 13 is parallel to the axis of the connector 110, so that a fan-shaped gap is provided between the upper connection seat 111 and the lower connection seat 112 to guide the water from the upper connection seat 111 to the lower connection seat 112. The upper end of the main body 120 is fixedly connected with the upper connection seat 122 through the first cover 140, and the outlet terminal 130 is fixedly connected to the lower end of the main body 120, an outlet cavity is formed in the main body 120, the lower connection seat 112 and the outlet terminal 130. In the present embodiment, the outlet terminal 130 comprises a fixed body 131 and a second cover 132, the fixed body 131 is fixedly connected with the second cover 132 to form two outlet functions, the fixed body 131 is provided with two water division holes 133 corresponding to the two outlet functions respectively and corresponding to the outlet cavity. The check ring 150 is resisted in the lower connection seat 112 by the returning body. the water division body 200 can be rotationally arranged in the main body 120, a plurality of lower ratchets in anuular array are arranged on the top surface of the water division body 200, and a plurality of cuboidical stopping teeth 220 in anuular array are arranged on the outer rotative surface of the water division body 200. The location hole 250 is arranged at the lower end of the water division body (a water passing hole 260 is additionally arranged to communicate the location hole with the outlet cavity.), a plugging ball 230 that is adaptive to the water division holes 133 is connected in the location hole, the water pressure in the outlet cavity can act on the plugging ball 230 through the location hole to increase sealing performance. The lower ratchet 210 is provided with a second vertical face 211, a second oblique guiding face 212 connected to the second vertical face 211, a third oblique guiding face 213 arranged between the second oblique guiding face 212 and the second vertical face 211, and the oblique direction of the third oblique guiding face 213 is opposite to the oblique direction of the second oblique guiding face 212. In the present embodiment, two perforative inlet holes 240 are opened on the water division body 200, and the upper ends of the two inlet holes 240 are both communicated with the outlet cavity. The lower end of the water division body 200 is hermetically connected to the fixed body 131. The lower ends of the two inlet holes 240 are corresponding to the water division holes 133.

The ratchet shaft 300 can be rotationally arranged in the main body 120 of the fixed unit 100 and is provided with a pulling block 310 extending out of the fixed unit and a convex ring 330 fixedly connected at the lower end of the ratchet shaft 300, the pulling block 310 can be synchronously rotationally sleeved and located on the ratchet shaft 300, and a plurality of upper ratchets 320 in anuular array are arranged on the bottom surface of the convex ring 330. The upper end of the ratchet shaft 300 is hinged to the upper connection seat 111, and the lower end is hermetically extended into the lower connection seat 112 and rotationally passes through the check ring 150; the convex ring 330 and the upper ratchets 320 are located in the main body 120, the pulling block 310 is located in the fan-shaped gap between the upper connection seat 111 and the lower connection seat 112 to be provided with enough giving-way space. The upper ratchet 320 is provided with two first vertical faces 321 and a first oblique guiding face 322 connected between the ends of the two first vertical faces 321. The first oblique guiding face 322 is adaptive and agreed with the second oblique guiding face 213, and the upper ratchets 320 are adaptive to the lower ratchets 210, and the ratchet shaft 300 can be driven rotate forward by the pulling block 310, and the water division body 200 can be driven rotate forward by the upper ratchets 320 through the lower ratchets 210, and the rotation axis of the water division body 200 is coincided with the rotation axis of the ratchet shaft 300.

The stopping claw is fixedly arranged in the fixed unit 100 through a vertical rod 410, and the end of the stopping claw 400 is adaptive to the stopping teeth 220 of the water division body 200 to prevent the water division reversing.

The returning body 500 is sleeved to the ratchet shaft 300 and connected between the convex ring 330 of the ratchet shaft 300 and the check ring 150 of the fixed unit 100 to cause the ratchet shaft 300 reverse and reset. The returning body 500 can be compression spring or torsional spring.

One end of the pulling wire 600 is connected to the end of the pulling block 310, and another end is best drooping.

The switching steps of the pulling-wire switch are:

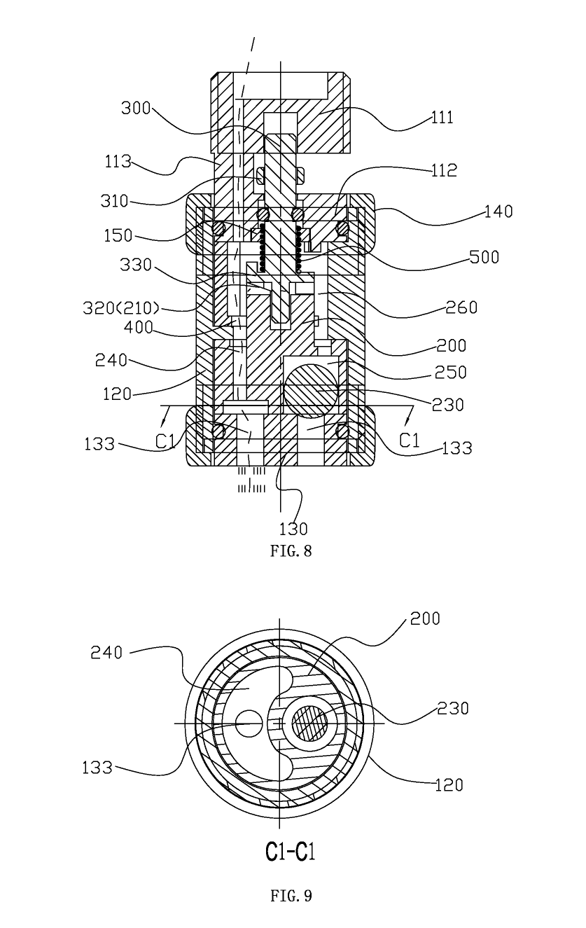

Step 00, according to FIGS. 8 and 9, the second water division hole 133 of the outlet terminal 130 is sealed by the plugging ball 230 of the water division body 200, and at this moment, water comes out of the first outlet function of the mechanism when the outlet cavity of the mechanism is aligned and communicated with the first water division through a inlet hole 240;

Step 10, the pulling wire 600 is pulled, and the ratchet shaft 300 is driven to rotates forward through the pulling block 310.

Step 20, the upper ratchet 320 is driven to rotate forward by the ratchet shaft 300, and one first vertical face 321 of the upper ratchet 320 acts on the second vertical face 211 of the lower ratchet 210 and the lower ratchet 210 is driven to rotate forward, and the water division body 200 is driven to rotate forward, and energy is stored in the returning body 500 at this moment, and the plugging ball 230 leaves the second water division hole 133;

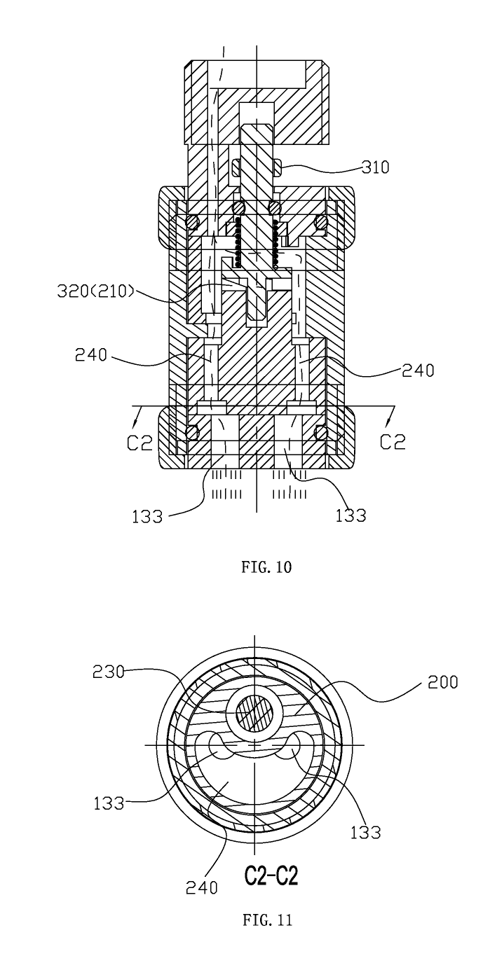

Step 30, According to FIGS. 10 and 11, after the water division 200 rotates 90 degrees, the stopping claw 400 is against the stopping teeth 220 to locate the water division body 200, and the plugging ball 230 is located between the first water division hole and the second water division hole, and at this moment, the lower ends of the two inlet holes 240 are aligned and communicated with the two water division holes, and water comes out of the first outlet function and the second outlet function;

Step 40, the pulling wire 600 is loosen, and the returning body 500 is reset, and the first oblique guiding face 322 of the upper ratchet 320 slides along the second oblique guiding face 212, when slides to the top end of the second oblique guiding face 212, namely the joint with the third oblique guiding face 213, the first oblique guiding face 322 slides downward along the third oblique guiding 213 (at this moment, elastic energy maybe still present in the returning body, and the elastic energy also acts on the ratchet shaft 300) and reset to the original position.

In the same way, the second state can be switched to the third state by the users, namely, water comes out of the second function.

The invention has been described with reference to the preferred embodiments mentioned above; therefore it cannot limit the reference implementation of the invention. It is obvious to a person skilled in the are that structural modification and changes can be carried out without leaving the scope of the claims hereinafter and the description above.

### INDUSTRIAL APPLICABILITY

The pulling-wire waterway switching mechanism can handily switch waterways through pulling a wire with simple structure, handily operation and good industrial applicability.

What is claimed is:

1. Pulling-wire waterway switching mechanism, wherein, comprises:
A fixed unit with a plurality of outlet functions;
A water division body, can be rotationally arranged in the fixed unit, and can use the rotation between the water division body and the fixed unit to achieve the switch of the outlet functions, a plurality of lower ratchets in anuular array are arranged on the top surface of the water division body, and a plurality of stopping teeth in anuular array are arranged on the outer rotative surface of the water division body;
A ratchet shaft, can be rotationally arranged in the fixed unit and is provided with a pulling block extending out of the fixed unit and a plurality of upper ratchets in annular array, and the upper ratchets are adaptive to the lower ratchets, and the ratchet shaft is driven to rotate forward by the pulling block, and the water division can be driven to rotate forward by the upper ratchets through the lower ratchets;
A stopping claw, one end is connected to the fixed unit, another end is adaptive to the stopping teeth to prevent the water division body reversing;
A returning body, is connected between the ratchet shaft and the fixed unit to cause the ratchet shaft reverse and reset; and
A pulling wire, one end is connected to the pulling block.

2. Pulling-wire waterway switching mechanism according to claim 1, wherein, the rotation axis of the water division body is coincided with the rotation axis of the ratchet shaft.

3. Pulling-wire waterway switching mechanism according to claim 1, wherein, the fixed unit comprises:
A connector, is provided with a upper connection seat, a lower connection seat and a connecting tube, the upper connection seat is connected to the water resource, the connecting tube is fixedly arranged between the upper connection seat and the lower connection seat and guides water from the upper connection seat to the lower connection seat;
A main body, is fixed to the lower connection seat; and
An outlet terminal, is fixed under the main body.

4. Pulling-wire waterway switching mechanism according to claim 3, wherein, the upper end of the ratchet shaft is hinged to the upper connection seat, the lower end rotationally extends into the lower connection seat, the upper ratchet is located in the main body, and the pulling block is located between the upper connection seat and the lower connection seat;
The water division body is located in the main body.

5. Pulling-wire waterway switching mechanism according to claim 4, wherein, the outlet terminal is provided with a plurality of outlet functions, and each outlet function is provided with a water division hole; a sealing component is arranged under the water division body, and the sealing component can seal any water division hole.

6. Pulling-wire waterway switching mechanism according to claim 1, wherein,
The upper ratchet is provided with two first vertical faces and a first oblique guiding face connected between the two ends of the two first vertical faces;
The lower ratchet is provided with a second vertical faces and a second oblique guiding face connected to the second vertical face, and the second oblique guiding face is adaptive to the first oblique guiding face.

7. Pulling-wire waterway switching mechanism according to claim 6, wherein, a third oblique guiding face is arranged between the second oblique guiding face and the second vertical face, and the oblique direction of the third oblique guiding face is opposite to the oblique direction of the second oblique guiding face.

8. Pulling-wire waterway switching mechanism according to claim 1, wherein, the stopping claw is fixedly arranged in the fixed unit through a vertical rod, and the stopping teeth are a plurality of cuboids arranged on the outer rotative surface of the water division body; the end of the stopping claw is adaptive to the stopping teeth of the water division body to limit the reversing of the water division.

9. Pulling-wire waterway switching mechanism according to claim 2, wherein,
The upper ratchet is provided with two first vertical faces and a first oblique guiding face connected between the two ends of the two first vertical faces;
The lower ratchet is provided with a second vertical faces and a second oblique guiding face connected to the second vertical face, and the second oblique guiding face is adaptive to the first oblique guiding face.

10. Pulling-wire waterway switching mechanism according to claim 3, wherein,
The upper ratchet is provided with two first vertical faces and a first oblique guiding face connected between the two ends of the two first vertical faces;
The lower ratchet is provided with a second vertical faces and a second oblique guiding face connected to the second vertical face, and the second oblique guiding face is adaptive to the first oblique guiding face.

11. Pulling-wire waterway switching mechanism according to claim 4, wherein,
The upper ratchet is provided with two first vertical faces and a first oblique guiding face connected between the two ends of the two first vertical faces;
The lower ratchet is provided with a second vertical faces and a second oblique guiding face connected to the second vertical face, and the second oblique guiding face is adaptive to the first oblique guiding face.

12. Pulling-wire waterway switching mechanism according to claim 5, wherein,
The upper ratchet is provided with two first vertical faces and a first oblique guiding face connected between the two ends of the two first vertical faces;
The lower ratchet is provided with a second vertical faces and a second oblique guiding face connected to the second vertical face, and the second oblique guiding face is adaptive to the first oblique guiding face.

13. Pulling-wire waterway switching mechanism according to claim 2, wherein, a third oblique guiding face is arranged between the second oblique guiding face and the second vertical face, and the oblique direction of the third oblique guiding face is opposite to the oblique direction of the second oblique guiding face.

14. Pulling-wire waterway switching mechanism according to claim 3, wherein, a third oblique guiding face is arranged between the second oblique guiding face and the second vertical face, and the oblique direction of the third oblique guiding face is opposite to the oblique direction of the second oblique guiding face.

15. Pulling-wire waterway switching mechanism according to claim 4, wherein, a third oblique guiding face is arranged between the second oblique guiding face and the second vertical face, and the oblique direction of the third oblique guiding face is opposite to the oblique direction of the second oblique guiding face.

16. Pulling-wire waterway switching mechanism according to claim 5, wherein, a third oblique guiding face is arranged between the second oblique guiding face and the second vertical face, and the oblique direction of the third oblique guiding face is opposite to the oblique direction of the second oblique guiding face.
